(19) United States
(12) Patent Application Publication
(10) Pub. No.: US 2025/0014139 A1
(43) Pub. Date: Jan. 9, 2025

(54) CONTROL DEVICE, CONTROL METHOD, AND CONTROL PROGRAM

(71) Applicant: FUJIFILM Corporation, Tokyo (JP)

(72) Inventors: Kazuki Ishida, Saitama-shi (JP); Kazuki Inoue, Saitama-shi (JP); Masahiko Miyata, Saitama-shi (JP)

(73) Assignee: FUJIFILM Corporation, Tokyo (JP)

(21) Appl. No.: 18/894,574

(22) Filed: Sep. 24, 2024

Related U.S. Application Data
(63) Continuation of application No. PCT/JP2023/008098, filed on Mar. 3, 2023.

(30) Foreign Application Priority Data
Mar. 25, 2022 (JP) 2022-049516

(51) Int. Cl. G06T 1/00; B05B 13/00; G06T 7/73

(52) U.S. Cl. CPC G06T 1/0014; B05B 13/005; G06T 7/74

(57) ABSTRACT

A control device includes: a processor, and the processor is configured to: acquire information indicating a positional relationship between a work apparatus and a work target object; and perform a control of projecting, from a projection apparatus, a work support image for supporting work to be performed by the work apparatus, based on the acquired information.

### CROSS REFERENCE TO RELATED APPLICATION

This is a continuation of International Application No. PCT/JP2023/008098 filed on Mar. 3, 2023, and claims priority from Japanese Patent Application No. 2022-049516 filed on Mar. 25, 2022, the entire disclosures of which are incorporated herein by reference.

### BACKGROUND OF THE INVENTION

### 1. Field of the Invention

The present invention relates to a control device, a control method, and a control program.

### 2. Description of the Related Art

JP2019-217431A discloses a spraying information creation method and a painting simulation method for virtual painting by performing a simulation considering a real paint spraying condition in performing a painting simulation using a painting robot.

JP2021-058866A discloses an ejection apparatus that ejects an ejection material such as a chemical agent to a target object. The ejection apparatus comprises a plurality of gimbals and an imaging unit and ejects the ejection material to the target object based on a captured image of the target object imaged by the imaging unit and on a distance to the target object measured by the imaging unit.

### SUMMARY OF THE INVENTION

One embodiment according to the disclosed technology provides a control device, a control method, and a computer readable medium storing a control program that can facilitate work performed by a work apparatus.

A control device according to an aspect of the present invention comprises a processor, in which the processor is configured to acquire information indicating a positional relationship between a work apparatus and a work target object, and perform a control of projecting a work support image for supporting work performed by the work apparatus from a projection apparatus based on the acquired information.

A control method according to an aspect of the present invention comprises, via a processor, acquiring information indicating a positional relationship between a work apparatus and a work target object, and performing a control of projecting a work support image for supporting work performed by the work apparatus from a projection apparatus based on the acquired information.

A control program, stored in a computer readable medium, according to an aspect of the present invention causes a processor to execute a process comprising acquiring information indicating a positional relationship between a work apparatus and a work target object, and performing a control of projecting a work support image for supporting work performed by the work apparatus from a projection apparatus based on the acquired information.

According to the present invention, a control device, a control method, and a computer readable medium storing a control program that can facilitate work performed by a work apparatus can be provided.

### BRIEF DESCRIPTION OF THE DRAWINGS

FIG. 1 is a diagram illustrating an example of a moving object 10 to which a control device according to an embodiment of the present invention can be applied.

FIG. 2 is a diagram illustrating an example of a configuration of the moving object 10.

FIG. 3 is a schematic diagram illustrating an example of an internal configuration of a projection apparatus 11.

FIG. 4 is a diagram illustrating an example of a hardware configuration of an information terminal 40.

FIG. 5 is a diagram illustrating examples of a painting result of the work apparatus 20.

FIG. 6 is a diagram (Part 1) illustrating an example of projection of a work support image from the projection apparatus 11.

FIG. 7 is a diagram (Part 2) illustrating an example of projection of the work support image from the projection apparatus 11.

FIG. 8 is a diagram illustrating an example of calculation of an estimated painting range shown by an estimated painting range image 61.

FIG. 9 is a diagram illustrating an example of projection of a target position image 90.

FIG. 10 is a diagram (Part 1) illustrating an example of projection of a reference position image for aligning the target position image 90 with a predetermined position.

FIG. 11 is a diagram (Part 2) illustrating an example of projection of the reference position image for aligning the target position image 90 with the predetermined position.

FIG. 12 is a diagram illustrating an example of notification in a case where a positional relationship between the projection apparatus 11 and a work target object 6 cannot be specified.

FIG. 13 is a diagram illustrating an example of projection of a work state image 131 showing a work state of the work apparatus 20.

FIG. 14 is a diagram (Part 1) illustrating an example of change of a projection setting of the work support image based on a specific change in a posture or a position of the projection apparatus 11.

FIG. 15 is a diagram (Part 2) illustrating an example of change of the projection setting of the work support image based on the specific change in the posture or the position of the projection apparatus 11.

FIG. 16 is a diagram illustrating an example of a captured image obtained by the information terminal 40.

### DESCRIPTION OF THE PREFERRED EMBODIMENTS

Hereinafter, an example of an embodiment of the present invention will be described with reference to the drawings.

### EMBODIMENT

<Moving Object 10 to which Control Device According to Embodiment of Present Invention Can Be Applied>

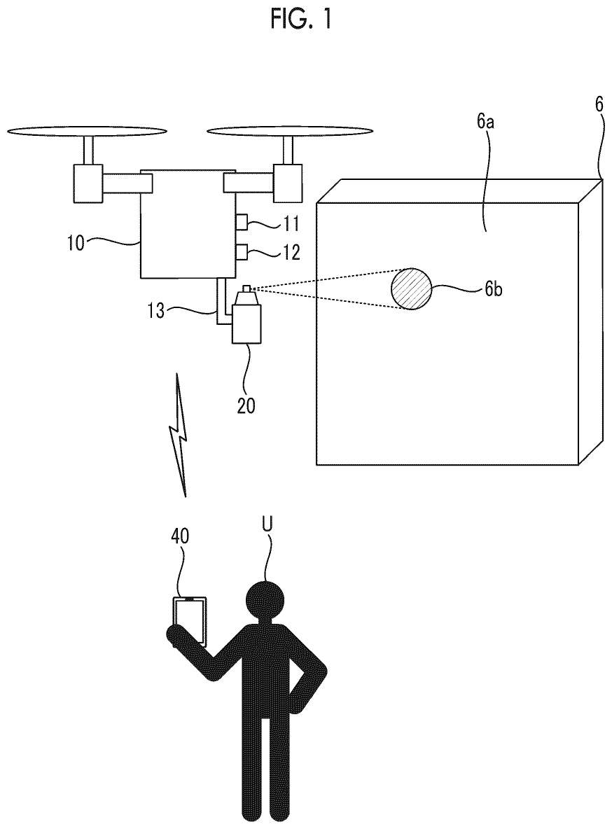

FIG. 1 is a diagram illustrating an example of a moving object 10 to which a control device according to the embodiment of the present invention can be applied. As illustrated in FIG. 1, the moving object 10 is a movable flying object and is, for example, an unmanned aerial vehicle also referred to as a drone. For example, the moving object 10 is a multicopter including three or more rotors (for example, four rotors).

A projection apparatus 11, an imaging apparatus 12, and a work apparatus 20 are mounted on the moving object 10. The projection apparatus 11 is a projection apparatus that can perform projection to a work target object 6. The imaging apparatus 12 can image the work target object 6. A work apparatus drive mechanism 13 drives the work apparatus 20. The work apparatus 20 is a spray that can eject a fluid to the work target object 6 and is an example of a fluid ejection apparatus. The fluid ejected by the work apparatus 20 is, for example, a paint for painting.

The work target object 6 is an object such as a wall and has a work surface 6a as a target for work performed by the work apparatus 20. In the example illustrated in FIG. 1, the work target object 6 is a rectangular cuboid. A painting range 6b simply indicates a range actually painted by the work apparatus 20 on the work surface 6a.

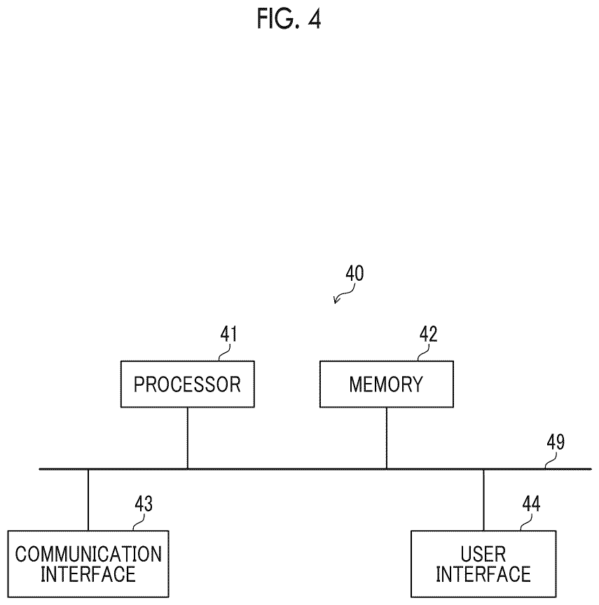

An information terminal 40 is an information terminal carried by a user U. The information terminal 40 can communicate with the moving object 10. In the example in FIG. 1, the information terminal 40 is a tablet terminal. The information terminal 40 is not limited to a tablet terminal and can be various information terminals such as a smartphone, a laptop personal computer, and a desktop personal computer. A configuration of the information terminal 40 will be described with reference to FIG. 4. The user U can perform various controls of the moving object 10 by operating the information terminal 40.

### <Configuration of Moving Object 10>

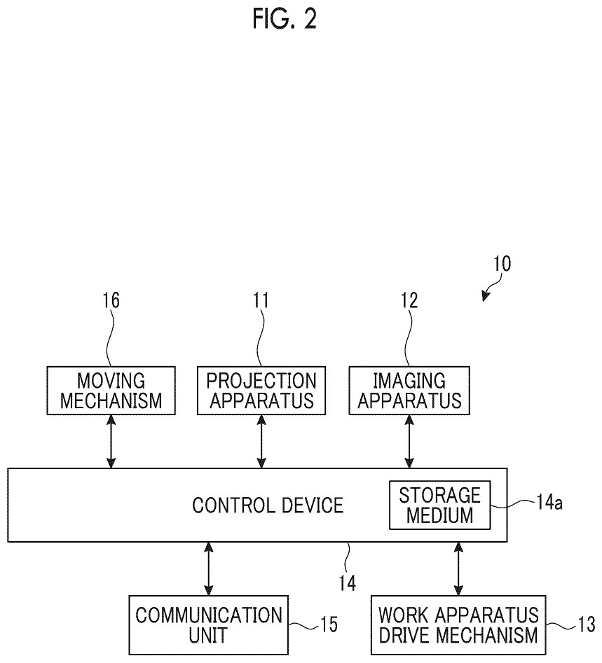

FIG. 2 is a diagram illustrating an example of a configuration of the moving object 10. As illustrated in FIG. 2, the moving object 10 comprises, for example, the projection apparatus 11, the imaging apparatus 12, the work apparatus drive mechanism 13, a control device 14, a communication unit 15, and a moving mechanism 16.

The projection apparatus 11 is composed of, for example, a liquid crystal projector or a projector using liquid crystal on silicon (LCOS). Hereinafter, the projection apparatus 11 will be described as a liquid crystal projector.

The imaging apparatus 12 is an imaging unit including an imaging lens and an imaging element. For example, a complementary metal-oxide-semiconductor (CMOS) image sensor can be used as the imaging element.

The work apparatus drive mechanism 13 drives the work apparatus 20 to eject the fluid to the work target object 6 from the work apparatus 20. In addition, the work apparatus drive mechanism 13 may control a posture of the work apparatus 20 with respect to a body of the moving object 10, strength of the ejection performed by the work apparatus 20, a diffusion degree of the ejection performed by the work apparatus 20, and the like.

The control device 14 performs various controls in the moving object 10. The control device 14 is an example of the control device according to the embodiment of the present invention. The controls performed by the control device 14 include, for example, a control of the projection performed by the projection apparatus 11, a control of the imaging performed by the imaging apparatus 12, a control of the ejection of the fluid performed by the work apparatus 20 through the work apparatus drive mechanism 13, a control of communication performed by the communication unit 15, and a control of movement of the moving object 10 performed by the moving mechanism 16.

The control device 14 is a device including a control unit composed of various processors, a communication interface (not illustrated) for communicating with each unit of the moving object 10, and a storage medium 14a such as a hard disk, a solid state drive (SSD), or a read only memory (ROM) and manages and controls the moving object 10. Examples of the various processors of the control unit of the control device 14 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

A structure of the various processors is more specifically an electric circuit in which circuit elements such as semiconductor elements are combined. The control unit of the control device 14 may be composed of one of the various processors or may be composed of a combination of two or more processors of the same type or different types (for example, a combination of a plurality of FPGAs or a combination of a CPU and an FPGA).

The communication unit 15 is a communication interface that can communicate with other apparatuses. For example, the communication unit 15 is a wireless communication interface that can perform wireless communication with the information terminal 40 on the ground while the moving object 10 is flying.

The moving mechanism 16 is a mechanism for moving the moving object 10. For example, in a case where the moving object 10 is a multicopter, the moving mechanism 16 includes four rotors, actuators such as motors that rotate the rotors, respectively, and a control circuit that controls each actuator. The number of rotors or the like included in the moving mechanism 16 may be three or may be five or more.

The projection apparatus 11, the imaging apparatus 12, the work apparatus drive mechanism 13, the control device 14, the communication unit 15, and the moving mechanism 16 are implemented as, for example, one apparatus mounted on the moving object 10. Alternatively, the projection apparatus 11, the imaging apparatus 12, the work apparatus drive mechanism 13, the control device 14, the communication unit 15, and the moving mechanism 16 may be implemented by a plurality of apparatuses that are mounted on the moving object 10 and that can cooperate with each other by communicating with each other.

### <Internal Configuration of Projection Apparatus 11>

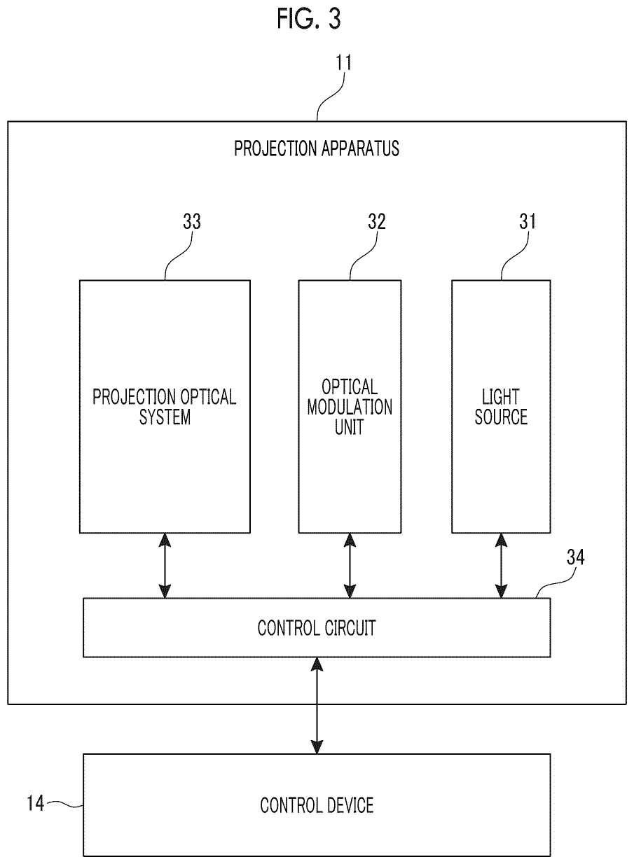

FIG. 3 is a schematic diagram illustrating an example of an internal configuration of the projection apparatus 11. The projection apparatus 11 of the moving object 10 illustrated in FIG. 2 comprises a light source 31, an optical modulation unit 32, a projection optical system 33, and a control circuit 34, as illustrated in FIG. 3. The light source 31 includes a light emitting element such as a laser or a light emitting diode (LED) and emits, for example, white light.

The optical modulation unit 32 is composed of three liquid crystal panels (optical modulation elements) that emit each color image by modulating each color light which is emitted from the light source 31 and which is separated into three colors of red, blue, and green by a color separation mechanism, not illustrated, based on image information, and a dichroic prism that mixes each color image emitted from the three liquid crystal panels and that emits the mixed color image in the same direction. Each color image may be emitted by mounting filters of red, blue, and green in the three liquid crystal panels, respectively, and modulating the white light emitted from the light source 31 using each liquid crystal panel.

The light from the light source 31 and the optical modulation unit 32 is incident on the projection optical system 33. The projection optical system 33 includes at least one lens and is composed of, for example, a relay optical system. The light that has passed through the projection optical system 33 is projected to the work target object 6.

A region irradiated with the light transmitted through the entire range of the optical modulation unit 32 on the work target object 6 is a projectable range to which the projection can be performed by the projection apparatus 11. A region with which the light actually transmitted from the optical modulation unit 32 is irradiated in the projectable range is a projection range of the projection apparatus 11. For example, a size, a position, and a shape of the projection range of the projection apparatus 11 are changed in the projectable range by controlling a size, a position, and a shape of the region through which the light is transmitted in the optical modulation unit 32.

The control circuit 34 projects an image based on display data input from the control device 14 to the work target object 6 by controlling the light source 31, the optical modulation unit 32, and the projection optical system 33 based on the display data. The display data input into the control circuit 34 is composed of three pieces of data including red display data, blue display data, and green display data.

In addition, the control circuit 34 enlarges or reduces the projection range of the projection apparatus 11 by changing the projection optical system 33 based on an instruction input from the control device 14. In addition, the control circuit 34 may move the projection range of the projection apparatus 11 by changing the projection optical system 33 based on an instruction input from the control device 14.

In addition, the projection apparatus 11 comprises a shift mechanism that mechanically or optically moves the projection range of the projection apparatus 11 while maintaining an image circle of the projection optical system 33. The image circle of the projection optical system 33 is a region in which projection light incident on the projection optical system 33 correctly passes through the projection optical system 33 in terms of light fall-off, color separation, edge part curvature, and the like.

The shift mechanism is implemented by at least any of an optical system shift mechanism that performs optical system shifting, or an electronic shift mechanism that performs electronic shifting.

The optical system shift mechanism is, for example, a mechanism that moves the projection optical system 33 in a direction perpendicular to an optical axis or a mechanism that moves the optical modulation unit 32 in the direction perpendicular to the optical axis instead of moving the projection optical system 33. In addition, the optical system shift mechanism may move the projection optical system 33 and move the optical modulation unit 32 in combination with each other.

The electronic shift mechanism is a mechanism that performs pseudo shifting of the projection range by changing a range through which the light is transmitted in the optical modulation unit 32.

In addition, the projection apparatus 11 may comprise a projection direction changing mechanism that moves the image circle of the projection optical system 33 and the projection range. The projection direction changing mechanism is a mechanism that changes a projection direction of the projection apparatus 11 by mechanically rotating to change a direction of the projection apparatus 11.

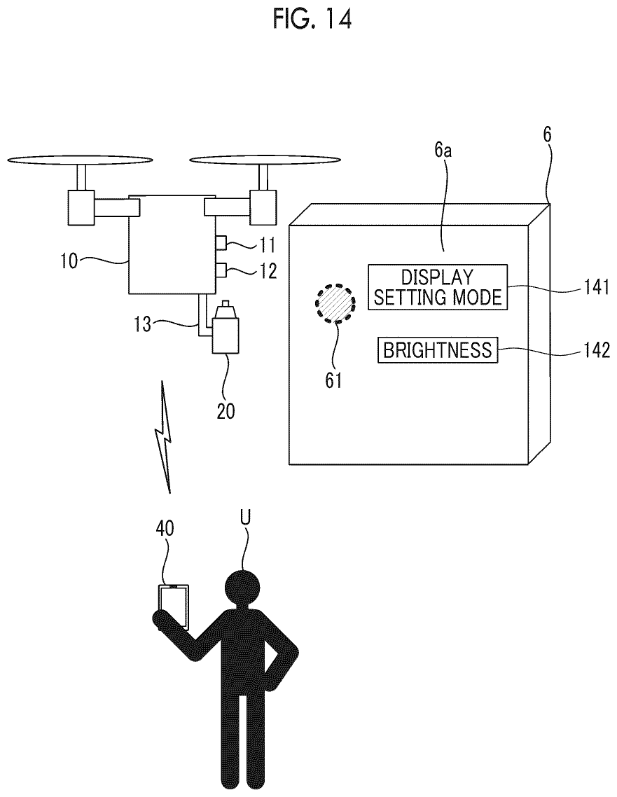

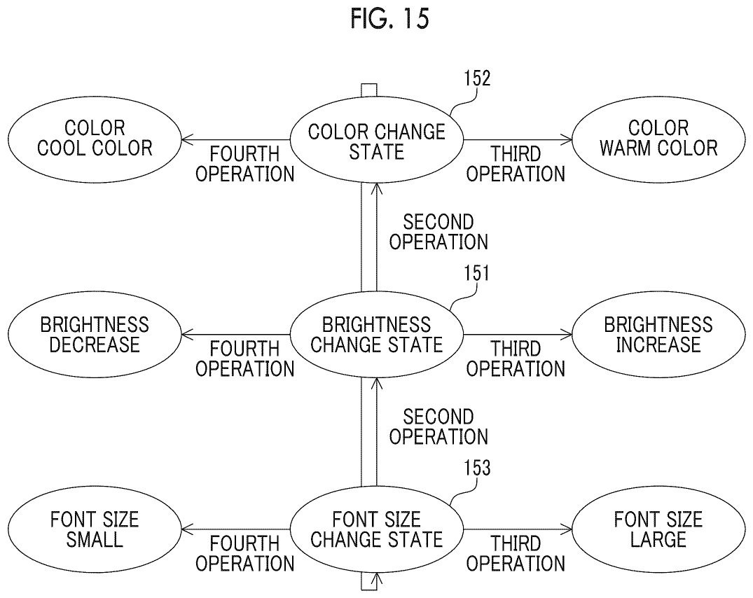

In addition, the projection apparatus 11 may comprise an accelerometer or a gyroscope that can detect a change in a posture or a position of the projection apparatus 11 (for example, refer to FIGS. 14 and 15).

### <Hardware Configuration of Information Terminal 40>

FIG. 4 is a diagram illustrating an example of a hardware configuration of the information terminal 40. As illustrated in FIG. 4, for example, the information terminal 40 illustrated in FIG. 1 comprises a processor 41, a memory 42, a communication interface 43, and a user interface 44. The processor 41, the memory 42, the communication interface 43, and the user interface 44 are connected to each other through, for example, a bus 49.

The processor 41 is a circuit that performs signal processing and is, for example, a central processing unit (CPU) that controls the entire information terminal 40. The processor 41 may be implemented by other digital circuits such as a field programmable gate array (FPGA) and a digital signal processor (DSP). In addition, the processor 41 may be implemented by combining a plurality of digital circuits with each other.

The memory 42 includes, for example, a main memory and an auxiliary memory. The main memory is, for example, a random access memory (RAM). The main memory is used as a work area of the processor 41.

The auxiliary memory is, for example, a non-volatile memory such as a magnetic disk, an optical disc, or a flash memory. The auxiliary memory stores various programs for operating the information terminal 40. The programs stored in the auxiliary memory are loaded into the main memory and executed by the processor 41.

In addition, the auxiliary memory may include a portable memory that can be detached from the information terminal 40. Examples of the portable memory include a universal serial bus (USB) flash drive, a memory card such as a secure digital (SD) memory card, and an external hard disk drive.

The communication interface 43 is a communication interface that performs wireless communication with an outside of the information terminal 40 (for example, the communication unit 15 of the moving object 10). The communication interface 43 is controlled by the processor 41.

The user interface 44 includes, for example, an input device that receives an operation input from the user, and an output device that outputs information to the user. The input device can be implemented by, for example, a key (for example, a keyboard) or a remote controller. The output device can be implemented by, for example, a display or a speaker. In addition, the input device and the output device may be implemented by a touch panel or the like. The user interface 44 is controlled by the processor 41.

### <Example of Painting Result of Work Apparatus 20>

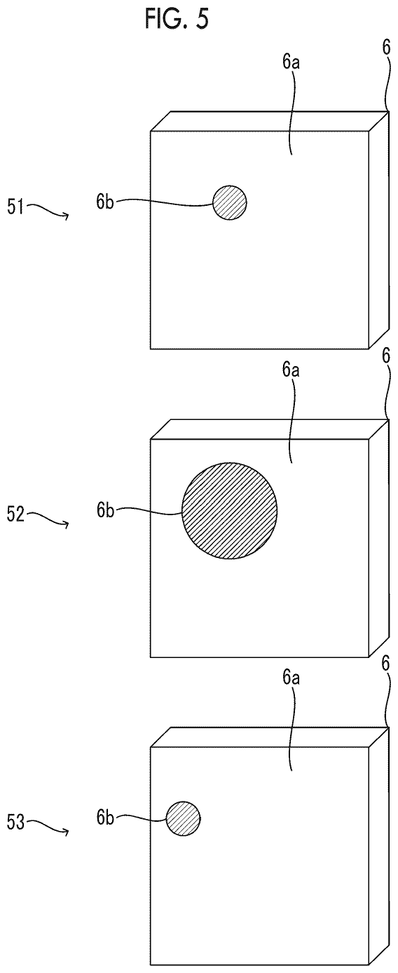

FIG. 5 is a diagram illustrating examples of a painting result of the work apparatus 20. Painting results 51 to 53 illustrated in FIG. 5 are examples of the painting result (work result) of the work apparatus 20.

For example, the painting result 51 is a state where the painting range 6b matches a painting range intended by the user U. Meanwhile, the painting result 52 is a state where the painting range 6b is larger than the painting range intended by the user U. The painting result 53 is a state where a position of the painting range 6b deviates from the painting range intended by the user U.

In the related art, it has been difficult for the user U to predict the painting results 51 to 53 until the user U actually performs painting by operating the work apparatus 20. However, the control device 14 predicts the painting results 51 to 53 (work results) of the work apparatus 20 for the work target object 6 and performs a control of projecting a work support image including images showing the painting results 51 to 53 to the work target object 6 from the projection apparatus 11.

<Projection of Work Support Image from Projection Apparatus 11>

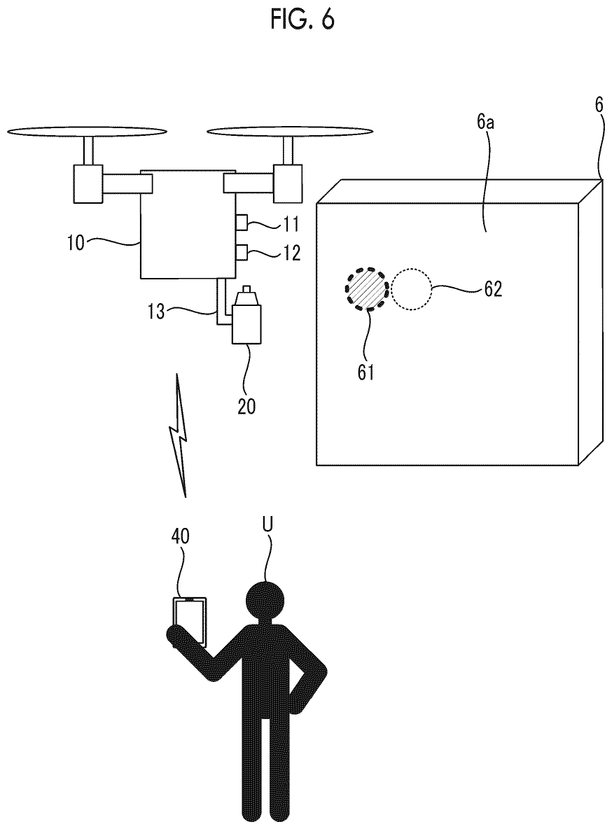

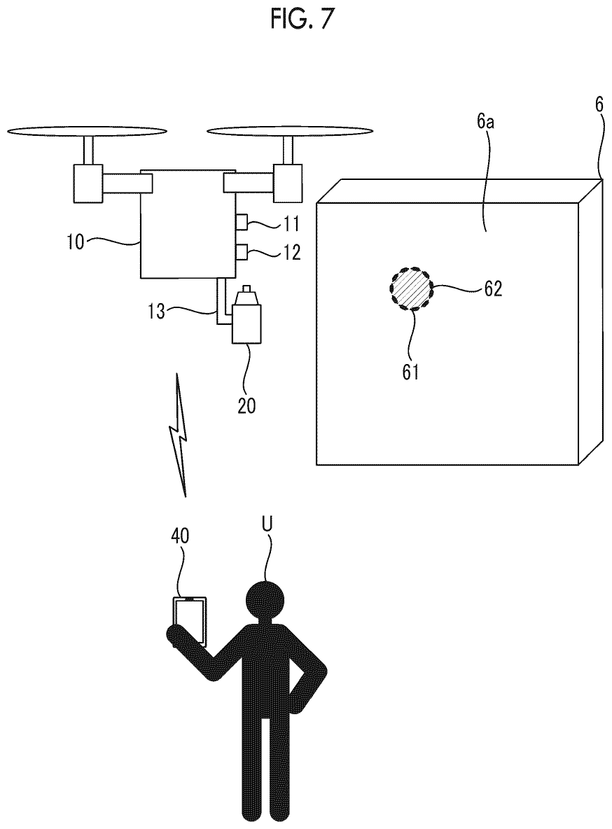

FIGS. 6 and 7 are diagrams illustrating examples of the projection of the work support image from the projection apparatus 11. The control device 14 acquires positional relationship information indicating a positional relationship between the work apparatus 20 and the work target object 6. The positional relationship between the work apparatus 20 and the work target object 6 includes, for example, a distance between the work apparatus 20 and the work target object 6 and directions of the work apparatus 20 and the work target object 6.

For example, the control device 14 acquires the positional relationship information indicating the positional relationship between the work apparatus 20 and the work target object 6 by performing image recognition based on image data obtained by imaging the work target object 6 via the imaging apparatus 12. That is, since the work apparatus 20 and the imaging apparatus 12 are mounted on the same moving object 10, a relative positional relationship between the work apparatus 20 and the imaging apparatus 12 is already known. Thus, the positional relationship information indicating the positional relationship between the work apparatus 20 and the work target object 6 can be acquired by performing the image recognition based on the image data obtained by imaging the work target object 6 via the imaging apparatus 12.

The control device 14 predicts a painting result (work result) of the work apparatus 20 for the work target object 6 based on the acquired positional relationship information and performs a control of projecting an estimated painting range image showing the painting result to the work target object 6 from the projection apparatus 11 as the work support image.

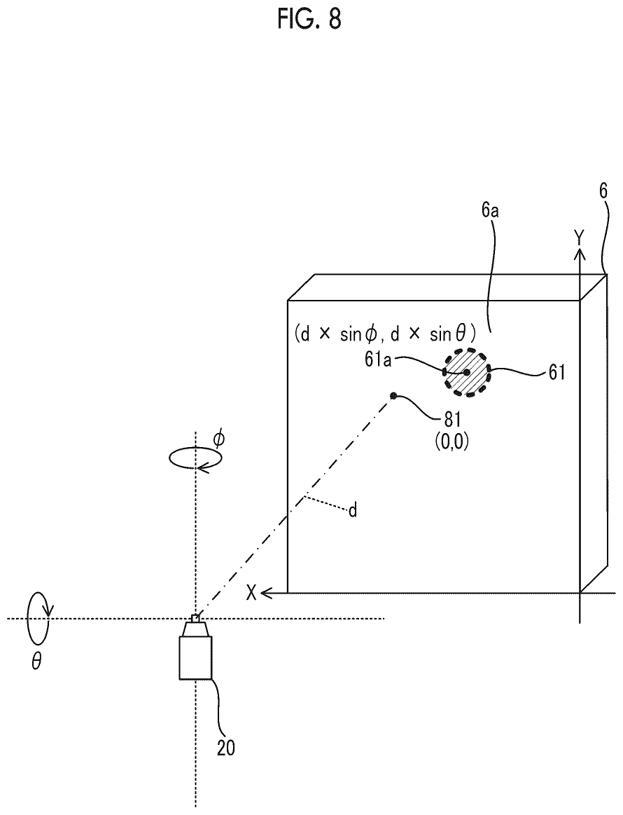

An estimated painting range image 61 illustrated in FIG. 6 is an image showing an estimated painting range on the work surface 6a in a case where the paint is ejected from the work apparatus 20 under a current work condition. The work condition is, for example, the positional relationship between the work apparatus 20 and the work target object 6 and a direction and the strength of the ejection performed by the work apparatus 20. Calculation of the estimated painting range will be described later (for example, refer to FIG. 8). In addition, the control device 14 performs a control of updating the estimated painting range image 61 to be projected to the work surface 6a in accordance with a change in the work condition.

A target painting range 62 illustrated in FIG. 6 is a target painting range intended by the user U on the work surface 6a and is actually not displayed on the work surface 6a. In the example illustrated in FIG. 6, the target painting range 62 is the same as the painting range 6b illustrated in FIG. 1.

In this case, the user U, by viewing the estimated painting range image 61, can recognize that the estimated painting range in a case where the paint is ejected from the work apparatus 20 under the current condition deviates leftward with respect to the target painting range 62 intended by the user U, before the ejection of the paint by the work apparatus 20.

Accordingly, the user U controls the moving object 10 to match the estimated painting range image 61 to the target painting range 62 by operating the information terminal 40. For example, the user U performs at least any of an operation of parallelly moving the moving object 10 rightward, an operation of rotating the moving object 10 rightward, or an operation of rotating the direction (ejection direction) of the work apparatus 20 rightward. Accordingly, for example, as illustrated in FIG. 7, the estimated painting range image 61 can be matched to the target painting range 62.

The user U performs an operation of ejecting the paint from the work apparatus 20 in a state where the estimated painting range image 61 is matched to the target painting range 62 as illustrated in FIG. 7. Accordingly, the user U can paint the target painting range 62 by ejecting the paint to the target painting range 62 intended by the user U from the work apparatus 20 (for example, refer to FIG. 1).

### <Calculation of Estimated Painting Range Shown by Estimated Painting Range Image 61>

FIG. 8 is a diagram illustrating an example of calculation of the estimated painting range shown by the estimated painting range image 61. A lateral direction of the work surface 6a is set as an X axis, and a longitudinal direction of the work surface 6a is set as a Y axis. The posture (direction) of the work apparatus 20 in which the ejection direction of the work apparatus 20 is perpendicular to the work surface 6a is referred to as a reference posture of the work apparatus 20. The posture of the work apparatus 20 is adjusted by at least any of a control of a posture of the moving object 10 on which the work apparatus 20 is mounted or a control of a relative posture of the work apparatus 20 with respect to the body of the moving object 10 using the work apparatus drive mechanism 13.

A reference point 81 is an intersection between the ejection direction of the work apparatus 20 and the work surface 6a in a case where the work apparatus 20 is in the reference posture. In an XY plane, XY coordinates of the reference point 81 are set to (0, 0). A distance d is a distance between the work apparatus 20 and the work surface 6a (reference point 81).

For example, in the example in FIG. 8, it is assumed that the work apparatus 20 is in a posture (direction) in which a yaw rotation of the work apparatus 20 is performed about an axis parallel to the Y axis by an angle q and a pitch rotation of the ejection direction is performed about an axis parallel to the X axis by an angle Θ with respect to the reference posture. In this case, the control device 14 acquires the distance d and the angles φ and Θ as the positional relationship information.

The control device 14 calculates XY coordinates of an estimated painting center point 61a that is a center point of the estimated painting range of the work apparatus 20, as (d×sin φ, d×sin Θ). In addition, the control device 14 calculates a radius R of the estimated painting range of the work apparatus 20 as R=d×α. Here, α is a coefficient corresponding to an ejection characteristic (diffusion degree) of the paint for the work apparatus 20 and is, for example, set in advance. In addition, in a case where the ejection characteristic of the paint for the work apparatus 20 can be controlled by the work apparatus drive mechanism 13, a may be acquired based on a control state of the work apparatus drive mechanism 13.

In addition, the control device 14 calculates an area of the estimated painting range of the work apparatus 20 about the estimated painting center point 61a as R²×π. The control device 14 calculates the estimated painting range of the work apparatus 20 in the XY plane of the work surface 6a based on the calculated XY coordinates of the estimated painting center point 61a and on the calculated area of the estimated painting range of the work apparatus 20, and projects the estimated painting range image 61 showing the calculated estimated painting range from the projection apparatus 11.

For example, the control device 14 generates a circular image having a pixel size based on a projection distance (for example, the distance d) between the projection apparatus 11 and the work surface 6a and on an angle of view of the projection performed by the projection apparatus 11, and projects the generated image from the projection apparatus 11 as the estimated painting range image 61 such that a projection center matches the estimated painting center point 61a.

As described above, the control device 14 decides at least any of a projection position or a projection size of the estimated painting range image 61 (work support image) on the work target object 6 based on the positional relationship information indicating the positional relationship between the work apparatus 20 and the work target object 6. Accordingly, the user U can recognize a position and a size of the painting range 6b in a case where the paint is ejected by the work apparatus 20 under the current work condition.

The control device 14 may calculate only the projection position (estimated painting center point 61a) of the estimated painting range image 61 on the work target object 6 based on the positional relationship information, and the size of the estimated painting range image 61 may be constant. Even in this case, the user U can recognize the position of the painting range 6b in a case where the paint is ejected by the work apparatus 20 under the current work condition.

In addition, the control device 14 may calculate only the size (radius R) of the estimated painting range image 61 on the work target object 6 based on the positional relationship information, and the projection position of the estimated painting range image 61 may be constant. Even in this case, the user U can recognize the size of the painting range 6b in a case where the paint is ejected by the work apparatus 20 under the current work condition.

### <Projection of Target Position Image 90>

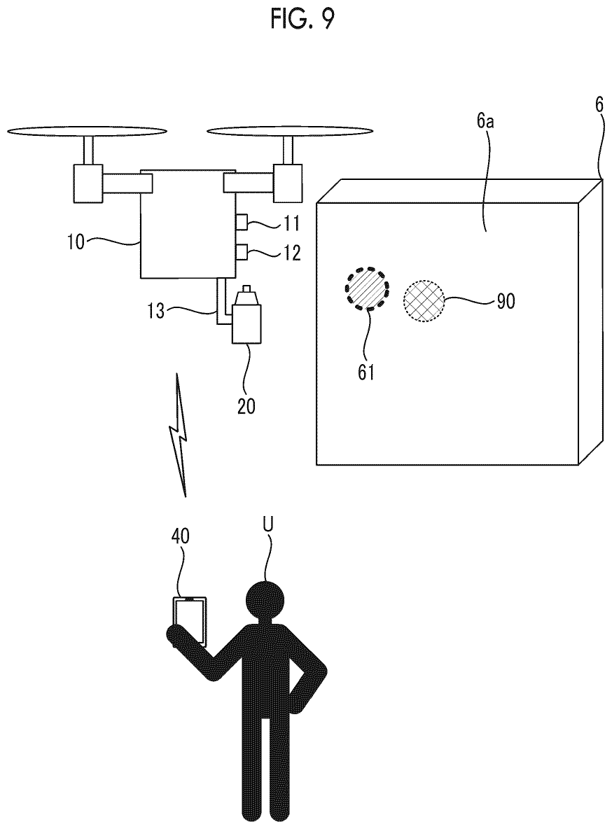

FIG. 9 is a diagram illustrating an example of projection of a target position image 90. In order for the user U to perform an operation of matching the estimated painting range image 61 of the work apparatus 20 to the target painting range 62, the control device 14 may project the target position image 90 showing the target painting range 62 intended by the user U to the work target object 6 from the projection apparatus 11 as the work support image, as illustrated in FIG. 9.

For example, the user U can change a position of the target position image 90 to any position upward, downward, leftward, or rightward with respect to the projection apparatus 11 by operating the information terminal 40. Furthermore, the user U may also change a size of the target position image 90 by operating the information terminal 40.

As described above, the control device 14 may project the target position image 90 showing a target position on the work target object 6 to the work target object 6 from the projection apparatus 11 as the work support image. Accordingly, for example, in a case where there is another user who supervises the work performed by the user U, the other user can easily recognize the target painting range 62 intended by the user U.

In addition, the user U can easily match the estimated painting range image 61 to the target painting range 62 by performing an operation of matching the estimated painting range image 61 to the position of the target position image 90 in a state where the position of the target position image 90 is aligned with the target painting range 62 intended by the user U.

In changing the position or the size of the estimated painting range image 61 through an operation performed by the user U, the control device 14 performs a control of maintaining the position or the size of the target position image 90 even in a case where a position or the posture of the moving object 10 changes. This control can be performed by, for example, performing image processing on a projection image including the target position image 90 projected from the projection apparatus 11.

<Projection of Reference Position Image for Aligning Target Position Image 90 with Predetermined Position>

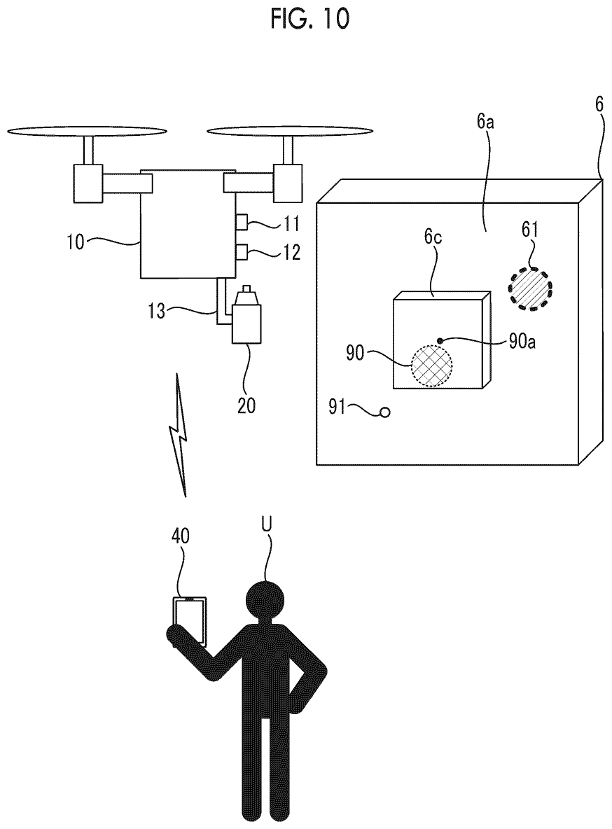

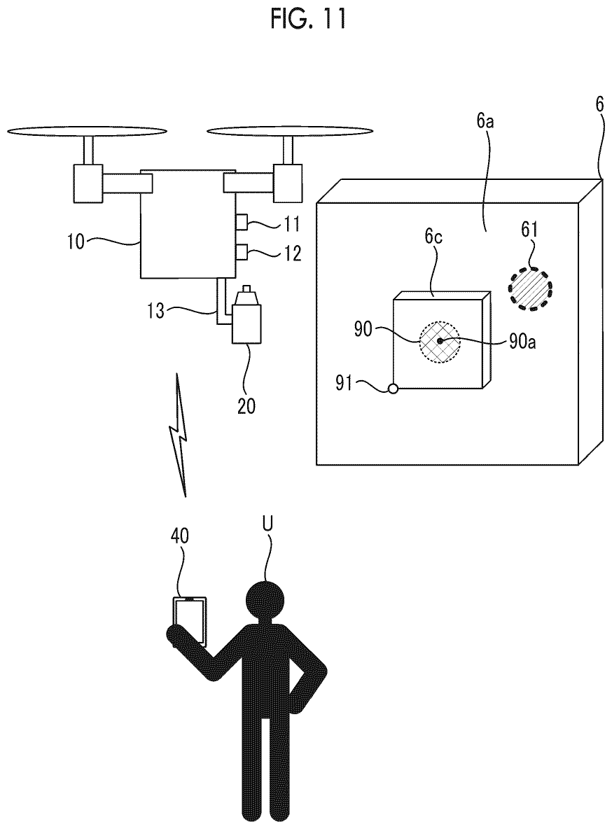

FIGS. 10 and 11 are diagrams illustrating examples of projection of a reference position image for aligning the target position image 90 with a predetermined position. A target position 90a illustrated in FIG. 10 is a target position (center position) of the painting performed by the work apparatus 20. In the example in FIG. 10, a protruding region 6c on a rectangular flat plate is present on the work surface 6a, and the target position 90a is determined as a position (for example, a position after moving rightward by X1 and upward by Y1) having a predetermined positional relationship with a specific position of the protruding region 6c (for example, a lower left corner of the protruding region 6c).

In this case, the control device 14 may project the reference position image 91 and the target position image 90 to the work target object 6 from the projection apparatus 11 as the work support image. The reference position image 91 is an image showing a reference position for registration. A relative position of the target position image 90 with respect to the reference position image 91 is set such that the target position image 90 is projected to the target position 90a by aligning the reference position image 91 with the specific position (for example, the lower left corner of the protruding region 6c) of the work target object 6.

For example, the control device 14 converts a distance between the specific position (for example, the lower left corner of the protruding region 6c) and the target position 90a into a distance (the number of pixels) in the projection image in accordance with a distance (for example, the distance d) between the projection apparatus 11 and the work target object 6, and disposes the reference position image 91 and the target position image 90 on the projection image at an interval of the converted distance.

As described above, the control device 14 projects the reference position image 91 showing the reference position and the target position image 90 to the work target object 6 from the projection apparatus 11 as the work support image based on information indicating a positional relationship (for example, a distance) between the projection apparatus 11 and the work target object 6. The user U controls the moving object 10 such that a position of the reference position image 91 is aligned with the specific position (for example, the lower left corner of the protruding region 6c) of the work target object 6 by operating the information terminal 40.

In the example in FIG. 10, the user U controls the moving object 10 such that the reference position image 91 and the target position image 90 are moved to the upper right. The control of moving the reference position image 91 and the target position image 90 to the upper right is implemented by, for example, a control for moving the reference position image 91 and the target position image 90 rightward and a control for moving the reference position image 91 and the target position image 90 upward.

The control for moving the reference position image 91 and the target position image 90 rightward is at least any of a control of parallelly moving the moving object 10 rightward, a control of rotating the moving object 10 rightward, a control of rotating the projection direction of the projection apparatus 11 rightward (yaw rotation), or a control of optically or electronically shifting a projection position of the projection apparatus 11 rightward. The control for moving the reference position image 91 and the target position image 90 upward is at least any of a control of parallelly moving the moving object 10 upward, a control of rotating (pitch rotation) the projection direction of the projection apparatus 11 upward, or a control of optically or electronically shifting the projection position of the projection apparatus 11 upward.

Accordingly, as illustrated in FIG. 11, the user U can easily align the target position image 90 with the target position 90a intended by the user U.

<Notification in Case where Positional Relationship Between Projection Apparatus 11 and Work Target Object 6 Cannot be Specified>

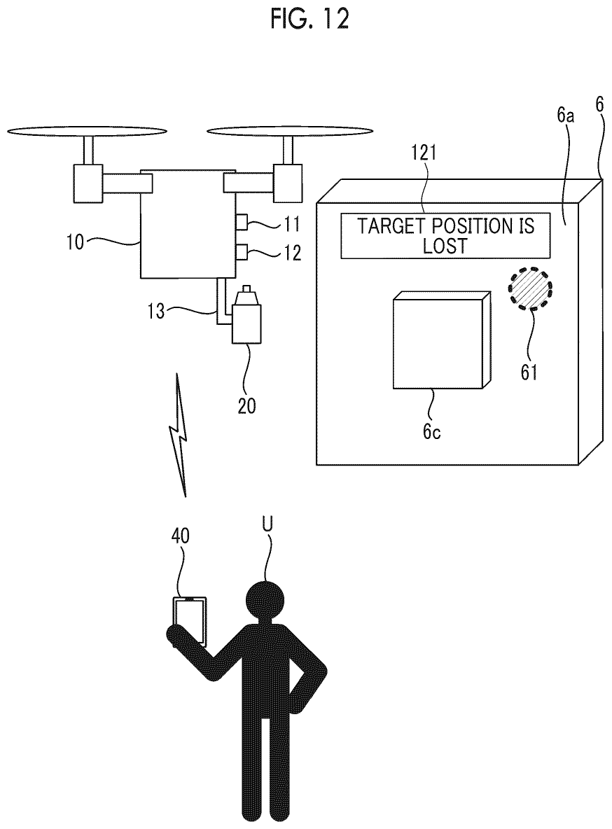

FIG. 12 is a diagram illustrating an example of notification in a case where the positional relationship between the projection apparatus 11 and the work target object 6 cannot be specified. For example, the control device 14 notifies the user U in a case where the control device 14 cannot specify the positional relationship between the projection apparatus 11 and the work target object 6 because of a disturbance. For example, the control device 14 controls the projection apparatus 11 to project a message 121 of “target position is lost” as an example to the work target object 6 from the projection apparatus 11. Accordingly, performing work based on an incorrect target can be prevented.

However, the notification in a case where the control device 14 cannot specify the positional relationship between the projection apparatus 11 and the work target object 6 is not limited to the projection performed by the projection apparatus 11 and may be performed by the information terminal 40 by transmitting a control signal to the information terminal 40 via the control device 14. For example, the control device 14 may perform a control of displaying the message 121 of “target position is lost” as an example on a screen of the information terminal 40.

### <Work State of Work Apparatus 20>

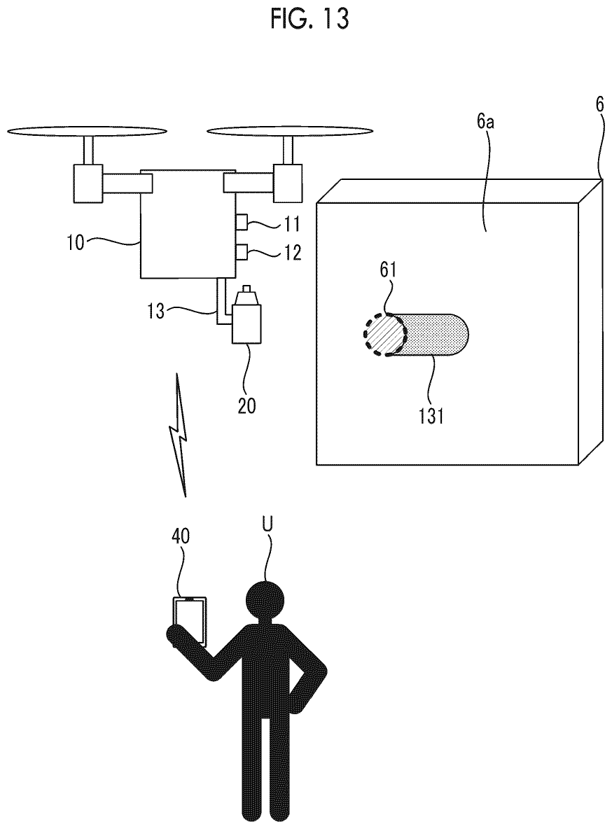

FIG. 13 is a diagram illustrating an example of projection of a work state image 131 showing a work state of the work apparatus 20. The control device 14 may project the work state image 131 showing the work state of the work apparatus 20 on the work target object 6 to the work target object 6 from the projection apparatus 11 together with the estimated painting range image 61. The work state image 131 is, for example, an image showing a region on which the painting (work) performed by the work apparatus 20 is completed on the work target object 6.

For example, the control device 14 maintains a paint ejection history of the work apparatus 20 corresponding to an instruction from the information terminal 40 provided by an operation performed by the user U. The ejection history is, for example, a history of the position (estimated painting center point 61a) and the radius R of the estimated painting range of the work apparatus 20 in a case where the ejection of the paint is executed by the work apparatus 20. The control device 14 calculates a region predicted to be painted by the work apparatus 20 on the work target object 6 based on the maintained ejection history and projects the work state image 131 showing the calculated region to the work target object 6 from the projection apparatus 11.

In the example in FIG. 13, painting is performed by the work apparatus 20 leftward from approximately a center of the work surface 6a, and the work state image 131 has a shape extending leftward from approximately the center of the work surface 6a to the current estimated painting range image 61.

Accordingly, for example, even in a case where it is not easy to visually recognize the paint ejected by the work apparatus 20, the user U can perform painting work using the work apparatus 20 while perceiving the region on which the painting is completed by visually recognizing the work state image 131.

### <Change of Projection Setting of Work Support Image Based on Specific Change in Posture or Position of Projection Apparatus 11>

FIGS. 14 and 15 are diagrams illustrating examples of change of a projection setting of the work support image based on a specific change in the posture or the position of the projection apparatus 11.

For example, the user U can indirectly instruct the projection apparatus 11 to transition to a display setting mode by instructing the moving object 10 to perform a first operation through the information terminal 40. The first operation is an operation of controlling at least any of the posture or the position of the moving object 10 and is an extreme operation that the moving object 10 is normally not instructed to perform. In addition, the first operation is desirably an operation of restoring the posture and the position of the moving object 10 to the posture and the position before the first operation. As an example, the first operation is an operation of raising the moving object 10 by a distance Δ and then lowering the moving object 10 by the distance Δ.

The projection apparatus 11 comprises an accelerometer or a gyroscope and can detect a change in the posture or the position of the projection apparatus 11. Since the posture or the position of the projection apparatus 11 mounted on the moving object 10 changes in accordance with a change in the posture or the position of the moving object 10, the projection apparatus 11 can detect the first operation. In a case where the projection apparatus 11 detects the first operation, the projection apparatus 11 transitions to the display setting mode.

In a case where the projection apparatus 11 transitions to the display setting mode, the projection apparatus 11 projects a mode display image 141 showing that a transition is made to the display setting mode and a change target display image 142 showing a current change target among items of the projection setting of the projection apparatus 11, to the work target object 6 as illustrated in FIG. 14. In the example in FIG. 14, the change target is brightness of the projection performed by the projection apparatus 11.

In the display setting mode, the projection apparatus 11 performs, for example, the operation illustrated in FIG. 15. For example, the projection apparatus 11 enters a brightness change state 151 immediately after transitioning to the display setting mode. The user U can indirectly instruct the projection apparatus 11 in the display setting mode to perform an operation in the display setting mode by instructing the moving object 10 to perform a second operation, a third operation, or a fourth operation through the information terminal 40.

The second operation, the third operation, and the fourth operation are operations different from the first operation and are operations different from each other. In addition, like the first operation, the second operation, the third operation, and the fourth operation are operations of controlling at least any of the posture or the position of the moving object 10 and are extreme operations that the moving object 10 is normally not instructed to perform. In addition, like the first operation, the second operation, the third operation, and the fourth operation are desirably operations of restoring the posture and the position of the moving object 10 to the posture and the position before each operation.

As an example, the second operation is an operation of lowering the moving object 10 by the distance Δ and then raising the moving object 10 by the distance Δ. The third operation is an operation of rotating the moving object 10 one round rightward (in a yaw direction). The fourth operation is an operation of rotating the moving object 10 one round leftward (in the yaw direction).

The projection apparatus 11 can detect the second operation, the third operation, and the fourth operation like the first operation. In a case where the projection apparatus 11 detects the second operation in the display setting mode, the projection apparatus 11 switches the current change target among the items of the projection setting of the projection apparatus 11.

For example, in a case where the projection apparatus 11 detects the second operation in the brightness change state 151 for changing the brightness of the projection performed by the projection apparatus 11, the projection apparatus 11 transitions to a color change state 152 for changing a color (for example, white balance) of the projection performed by the projection apparatus 11. In addition, in a case where the projection apparatus 11 detects the second operation in the color change state 152, the projection apparatus 11 transitions to a font size change state 153 for changing a font size of a text (for example, the mode display image 141 or the change target display image 142) projected by the projection apparatus 11. In addition, in a case where the projection apparatus 11 detects the second operation in the font size change state 153, the projection apparatus 11 is restored to the brightness change state 151.

In addition, in a case where the projection apparatus 11 detects the third operation in the brightness change state 151, the projection apparatus 11 increases the brightness of the projection performed by the projection apparatus 11 by a certain degree. In addition, in a case where the projection apparatus 11 detects the fourth operation in the brightness change state 151, the projection apparatus 11 decreases the brightness of the projection performed by the projection apparatus 11 by a certain degree.

In addition, in a case where the projection apparatus 11 detects the third operation in the color change state 152, the projection apparatus 11 changes the color of the projection performed by the projection apparatus 11 to a warm color side by a certain degree. In addition, in a case where the projection apparatus 11 detects the fourth operation in the color change state 152, the projection apparatus 11 changes the color of the projection performed by the projection apparatus 11 to a cool color side by a certain degree.

In addition, in a case where the projection apparatus 11 detects the third operation in the font size change state 153, the projection apparatus 11 increases the font size of the text projected by the projection apparatus 11 by a certain degree. In addition, in a case where the projection apparatus 11 detects the fourth operation in the font size change state 153, the projection apparatus 11 decreases the font size of the text projected by the projection apparatus 11 by a certain degree.

These changes in the projection setting are reflected in real time on the projection of the work support image such as the estimated painting range image 61.

As described above, the user U causes the projection apparatus 11 to transition to the display setting mode by instructing the moving object 10 to perform the first operation through the information terminal 40 and then instructs the moving object 10 to perform the second operation, the third operation, and the fourth operation through the information terminal 40. Accordingly, the user U can instruct the projection apparatus 11 to change the projection setting of the work support image from the information terminal 40 even in a case where the projection apparatus 11 does not have a configuration for directly communicating with the information terminal 40 and without passing through the control device 14. Thus, a configuration of the projection apparatus 11 can be simplified. In addition, a processing load of the control device 14 can be reduced.

Specific examples of the first operation, the second operation, the third operation, and the fourth operation described above are merely examples and can be changed, as appropriate. For example, the specific examples of the first operation, the second operation, the third operation, and the fourth operation described above may be replaced with each other. In addition, the first operation, the second operation, the third operation, and the fourth operation described above may be operations related to the posture or the position of the moving object 10 other than the operations described above.

### <Captured Image Obtained by Information Terminal 40>

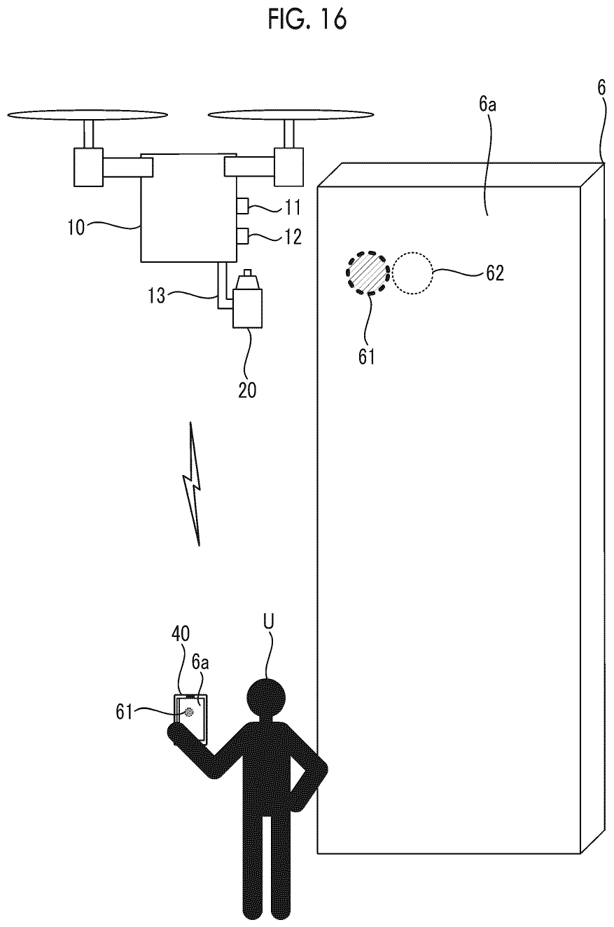

FIG. 16 is a diagram illustrating an example of a captured image obtained by the information terminal 40. The control device 14 may transmit the image data obtained by the imaging performed by the imaging apparatus 12 to the information terminal 40 and perform a control of displaying the captured image on the information terminal 40.

For example, as in the example in FIG. 16, in a case where the work target object 6 is a tall object and where work is performed by the work apparatus 20 on an upper portion of the work target object 6, it is not easy for the user U to visually recognize a region of a work target on the work target object 6 or the estimated painting range image 61 projected to the region. By displaying the captured image in which the region of the work target on the work target object 6 is captured on the imaging apparatus 12 via the information terminal 40, the user U can provide various instructions to the moving object 10 by operating the information terminal 40 while visually recognizing a state of the region of the work target and the work support image such as the estimated painting range image 61 using the information terminal 40.

In this case, the user U may be present at a place remote from the work target object 6 in a case where the information terminal 40 and the moving object 10 can directly or indirectly communicate with each other.

### MODIFICATION EXAMPLE

### <Other Examples of Method of Acquiring Positional Relationship Information>

While a configuration for acquiring the positional relationship information indicating the positional relationship between the work apparatus 20 and the work target object 6 by performing the image recognition based on the image data obtained by imaging the work target object 6 via the imaging apparatus 12 has been described, the present invention is not limited to this configuration. For example, in a case where a space recognition sensor is mounted on the moving object 10, it may be configured to acquire the positional relationship information indicating the positional relationship between the work apparatus 20 and the work target object 6 based on a recognition result of the space recognition sensor.

### <Other Examples of Moving Object 10>

While a configuration in which the moving object 10 is a multicopter has been described, the moving object 10 may be an aircraft (flying object) other than a multicopter. In addition, the moving object 10 is not limited to a flying object and may be a vehicle, a robot, or the like that travels or walks on the ground.

### <Other Examples of Fluid Ejected by Work Apparatus 20>

While a configuration in which the fluid ejected by the work apparatus 20 is the paint has been described, the fluid ejected by the work apparatus 20 is not limited to the paint and may be a functional fluid such as a protective, insecticidal, sterilizing, disinfecting, antimicrobial, or antiviral fluid. In addition, the work apparatus 20 may be a cleaning apparatus that jets water or air as the fluid.

<Other Examples of Location to which Work Support Image is Projected>

While a configuration for projecting the work support image for supporting the work performed by the work apparatus 20 to the work target object 6 from the projection apparatus 11 has been described, a location to which the work support image is projected is not limited to the work target object 6 and may be, for example, augmented reality (AR) glasses of a user who operates the work performed by the work apparatus 20.

### <Other Examples of Projection Apparatus 11>

While a configuration in which the projection apparatus 11 is mounted on the moving object 10 has been described, the present invention is not limited to this configuration. For example, the projection apparatus 11 may be a projection apparatus fixed to the ground or may be a projection apparatus provided in the information terminal 40.

### <Other Examples of Imaging Apparatus 12>

While a configuration in which the imaging apparatus 12 is mounted on the moving object 10 has been described, the present invention is not limited to this configuration. For example, the imaging apparatus 12 may be an imaging apparatus fixed to the ground or may be an imaging apparatus provided in the information terminal 40.

### <Other Examples of Work Apparatus 20>

While a configuration in which the work apparatus 20 is mounted on the moving object 10 has been described, the present invention is not limited to this configuration. For example, the work apparatus 20 may be a work apparatus mounted on a moving object different from the moving object 10 or may be a work apparatus fixed to the ground. In addition, while a configuration in which the control device 14 controls the work performed by the work apparatus 20 has been described, it may be configured to cause the user U to operate the work performed by the work apparatus 20.

### <Other Examples of Control Device>

While a case where the control device according to the embodiment of the present invention is applied to the control device 14 of the moving object 10 has been described, the present invention is not limited to this configuration. The control device according to the embodiment of the present invention may be applied to, for example, the information terminal 40. In this case, the information terminal 40 executes the same controls as the various controls performed by the control device 14 by communicating with the moving object 10.

At least the following matters are described in the present specification.
(1) A control device comprising a processor, in which the processor is configured to acquire information indicating a positional relationship between a work apparatus and a work target object, and perform a control of projecting a work support image for supporting work performed by the work apparatus from a projection apparatus based on the acquired information.
(2) The control device according to (1), in which the work apparatus is controllable.
(3) The control device according to (1) or (2), in which the processor is configured to determine at least any of a projection position or a projection size of the work support image on the work target object based on the information.
(4) The control device according to any one of (1) to (3), in which the processor is configured to estimate a work result of the work apparatus for the work target object based on the information, and the work support image includes an image showing the work result.
(5) The control device according to any one of (1) to (4), in which an imaging apparatus is controllable, and the processor is configured to acquire the information indicating the positional relationship between the work apparatus and the work target object based on image data obtained by imaging performed by the imaging apparatus.
(6) The control device according to any one of (1) to (5), in which a moving object on which the work apparatus and the projection apparatus are mounted is controllable.
(7) The control device according to (6), in which the projection apparatus changes a projection setting of the work support image based on a specific change in at least any of a posture or a position of the projection apparatus or the moving object.
(8) The control device according to any one of (1) to (7), in which the work support image includes an image showing a target position of the work performed by the work apparatus on the work target object.
(9) The control device according to (8), in which the work support image includes a reference position image showing a reference position and a target position image that is projected to the target position by aligning the reference position image with a specific position of the work target object.
(10) The control device according to (9), in which the processor is configured to project the work support image including the reference position image and the target position image based on information indicating a positional relationship between the projection apparatus and the work target object and perform notification in a case where the positional relationship between the projection apparatus and the work target object is not specifiable.
(11) The control device according to any one of (1) to (10), in which the work support image includes an image showing a work state of the work apparatus on the work target object.
(12) The control device according to (11), in which the image showing the work state includes an image showing a region on which the work performed by the work apparatus is completed.
(13) The control device according to any one of (1) to (12), in which the work apparatus is a fluid ejection apparatus that ejects a fluid.
(14) A control method comprising, via a processor, acquiring information indicating a positional relationship between a work apparatus and a work target object, and performing a control of projecting a work support image for supporting work performed by the work apparatus from a projection apparatus based on the acquired information.
(15) A control program for causing a processor to execute a process comprising acquiring information indicating a positional relationship between a work apparatus and a work target object, and performing a control of projecting a work support image for supporting work performed by the work apparatus from a projection apparatus based on the acquired information.

While various embodiments have been described above, the present invention is, of course, not limited to such examples. It is apparent that those skilled in the art may perceive various modification examples or correction examples within the scope according to the claims, and those examples are also understood as falling within the technical scope of the present invention. In addition, constituents in the embodiment may be used in any combination with each other without departing from the gist of the invention.

The present application is based on Japanese Patent Application (JP2022-049516) filed on Mar. 25, 2022, the content of which is incorporated in the present application by reference.

### EXPLANATION OF REFERENCES

6: work target object
6a: work surface
6b: painting range
6c: protruding region
10: moving object
11: projection apparatus
12: imaging apparatus
13: work apparatus drive mechanism
14: control device
14a: storage medium
15: communication unit
16: moving mechanism
20: work apparatus
31: light source
32: optical modulation unit
33: projection optical system
34: control circuit
40: information terminal
41: processor
42: memory
43: communication interface
44: user interface
49: bus
51 to 53: painting result
61: estimated painting range image
61a: estimated painting center point
62: target painting range
81: reference point
90: target position image
90a: target position
91: reference position image
121: message
131: work state image
141: mode display image
142: change target display image
151: brightness change state
152: color change state
153: font size change state

What is claimed is:

1. A control device comprising:
a processor,
wherein the processor is configured to:
acquire information indicating a positional relationship between a work apparatus and a work target object; and
perform a control of projecting, from a projection apparatus to the work target object, a work support image for supporting work to be performed by the work apparatus, based on the acquired information.

2. The control device according to claim 1,
wherein the work apparatus is controllable.

3. The control device according to claim 1,
wherein the processor is configured to determine at least one of a projection position or a projection size of the work support image on the work target object based on the information.

4. The control device according to claim 1,
wherein the processor is configured to estimate a work result of the work apparatus for the work target object based on the information, and
the work support image includes an image showing the work result.

5. The control device according to claim 1,
wherein an imaging apparatus is controllable, and
the processor is configured to acquire the information indicating the positional relationship between the work apparatus and the work target object based on image data obtained by imaging performed by the imaging apparatus.

6. The control device according to claim 1,
wherein a moving object on which the work apparatus and the projection apparatus are mounted is controllable.

7. The control device according to claim 6,
wherein the projection apparatus changes a projection setting of the work support image based on a specific change in at least one of a posture or a position of the projection apparatus or the moving object.

8. The control device according to claim 1,
wherein the work support image includes an image showing a target position of the work to be performed by the work apparatus on the work target object.

9. The control device according to claim 1,
wherein the work support image includes an image showing a work state of the work apparatus on the work target object.

10. The control device according to claim 9,
wherein the image showing the work state includes an image showing a region on which the work performed by the work apparatus is completed.

11. The control device according to claim 1,
wherein the work apparatus is a fluid ejection apparatus that ejects a fluid.

12. A control method comprising:
by a processor,
acquiring information indicating a positional relationship between a work apparatus and a work target object; and
performing a control of projecting, from a projection apparatus to the work target object, a work support image for supporting work to be performed by the work apparatus, based on the acquired information.

13. A non-transitory computer readable medium storing a control program for causing a processor to execute a process comprising:
acquiring information indicating a positional relationship between a work apparatus and a work target object; and
performing a control of projecting, from a projection apparatus to the work target object, a work support image for supporting work to be performed by the work apparatus based on the acquired information.

14. A control device comprising:
a processor,
wherein the processor is configured to:
acquire information indicating a positional relationship between a work apparatus and a work target object; and
perform a control of projecting, from a projection apparatus, a work support image for supporting work to be performed by the work apparatus, based on the acquired information,
the work support image includes a reference position image showing a reference position and a target position image that is to be projected to a target position by aligning the reference position image with a specific position of the work target object, and
the target position is a target position of the work to be performed by the work apparatus on the work target object.

15. The control device according to claim 14,
wherein the processor is configured to project the work support image including the reference position image and the target position image based on information indicating a positional relationship between the projection apparatus and the work target object, and perform notification in a case where the positional relationship between the projection apparatus and the work target object can not be specified.
